(19) United States
(12) Patent Application Publication
(10) Pub. No.: US 2002/0152094 A1
(43) Pub. Date: Oct. 17, 2002

(54) Method and system for supporting infrastructure delivery in a computer network

(76) Inventor: Christer Fahraeus, Lund (SE)

Correspondence Address: BIRCH STEWART KOLASCH & BIRCH, PO BOX 747, FALLS CHURCH, VA, 22040-0747, US

(21) Appl. No.: 10/101,929

(22) Filed: Mar. 21, 2002

Related U.S. Application Data
(60) Provisional application No. 60/304,742, filed on Jul. 13, 2001.
(60) Provisional application No. 60/277,285, filed on Mar. 21, 2001.
(60) Provisional application No. 60/281,786, filed on Apr. 6, 2001.

(51) Int. Cl. G06F 17/60

(52) U.S. Cl. 705/1

(57) ABSTRACT

A method and system are described for affecting the rate of introduction of a technological infrastructure including a digital pen and digital paper to establish a demand for a network of infrastructure dependent technological services. Revenues are collected from subscribers and a portion allocated to manufacturers and distributors. Production is increased based on the allocated portion revenues to increase the technological infrastructure including a position indicia reading stylus and a paper having a position defining indicia incorporated with a surface thereof. Services are provided and revenues collected through an intermediate service provider including a wireless service provider.

### CROSS-REFERENCE TO RELATED APPLICATIONS

This application claims priority under 35 U.S.C. §119 of U.S. Provisional Applications No. 60/304,742, entitled Communications System and Method for Supporting a Technology Provider of a Communications Network and filed on Jul. 13, 2001, No. 60/277,285, entitled Communications Services, Methods and Systems and filed Mar. 21, 2001, and No. 60/281,786, entitled Methods and System for Communications Service Revenue Collection and filed Apr. 6, 2001, the entire contents of which are incorporated herein by reference.

### BACKGROUND OF THE INVENTION

1. Field of the Invention

The present invention relates generally to data processing systems and, more particularly, to a system and method for supporting the provision of services in a computer network.

2. Description of Related Art

Network enabled computers or other communications devices allow individuals to electronically communicate and to electronically conduct business transactions. For example, e-mail is often used for message transmission, and Internet web sites permit procurement of information, goods, and services over a network.

The manner in which a network may be accessed can vary depending on the type of hardware being used. For example, access to a mobile phone network often occurs using keys on the mobile phone, or in some instances through voice commands. Network access through a Personal Digital Assistant (PDA) may be achieved using a stylus on a touch-sensitive surface, and network access through a personal computer or laptop is often achieved through a keyboard or mouse.

As input technology has advanced, and as network access becomes easier through the proliferation of, for example, localized proximity oriented communication/network access protocols like Bluetooth, conventional network based communications and transactions may be impeded by input devices users find cumbersome or awkward. Further, with the diversity of fee-based services provided over, for example, the Internet, and the corresponding diversity of input technologies or at least types of inputs or destinations which a given input technology may want to access, and with the relative infancy of such fee-based services, problems arise in proliferating enough units of the input technology to users to support the provision of the fee-based service initially to the limited initial subscriber base.

In addition, problems arise in that fee collection for transactions associated with the provision of fee-based services in a computer network may be impeded by many factors such as the existence of an intermediate service provider between a subscriber to fee-based services and the actual fee-based service provider. Unfortunately, direct billing for individual fee-based services can create problems for subscribers in that for every separate input technology and fee-based service, a different bill may be received. Accordingly, methods of payment which unduly burden subscribers and weak proliferation of input technologies associated with fee-based services may inhibit wide spread adoption of the technology.

It would therefore be appreciated in the art for a method and system for supporting the provision of services by aiding the proliferation of input technologies and simplifying payment transactions.

### SUMMARY OF THE INVENTION

Thus to address these and other problems in the art, a method and system are provided for affecting the rate of introduction of a technological infrastructure, such as a base of digital pens and digital paper to be described in greater detail hereinafter. By establishing a demand for a network of infrastructure dependent technological services, revenues may be collected from one or more subscribers to the infrastructure dependent technological services. Such services can be wide ranging but could include for example, catalog services, email services, and the like. In accordance with various exemplary embodiments of the present invention, a portion of the collected revenues may be allocated to one or more manufacturers of one or more enabling technologies associated with the technological infrastructure, the enabling technologies including for example the digital pen and digital paper. Accordingly, production of the one or more enabling technologies may be increased based on the allocated portion of the collected revenues. By increasing production and distribution of the enabling technologies, the collected revenues will increase based on an increase in size of the user base and associated technological infrastructure.

In accordance with various exemplary embodiments of the present invention, the enabling technologies, e.g., the digital pen and digital paper, may be further described as including a position indicia reading stylus and a paper having a position defining indicia incorporated with a surface thereof and the manufacturers may include a position indicia reading stylus manufacturer and a manufacturer of a paper, or like surface, having a position defining indicia incorporated with a surface thereof.

In accordance with various alternative exemplary embodiments of the present invention, revenues may be collected by providing the infrastructure dependent technological services from a technological service provider through an intermediate service provider and collecting the revenues using the intermediate service provider such as, for example, a wireless service provider or the like. The infrastructure dependent technological service includes a service for receiving a signal from the position indicia reading stylus or digital pen, the signal representative of the position of the position indicia reading stylus on the paper based on reading the pattern and providing one or more additional services based on the represented position of the position indicia reading stylus on the paper.

Further in accordance with various alternative exemplary embodiments of the present invention, collected revenues may be allocated to affect the rate of introduction of a technological infrastructure. It will be appreciated that it is preferably to increase the size of the technological infrastructure to establish a demand for a network of infrastructure dependent technological services supplied by a technological service provider through at least one intermediate service provider. Accordingly, revenues may be collected from one or more subscribers to the infrastructure dependent technological services. It should be noted that revenues may be collected from one or more, e.g., one or a combination of: the technological service provider, and the one or more intermediate service provider. A portion of the collected revenues may then be allocated to manufacturers and distributors of the enabling technologies at a percentage agreed upon. The enabling technologies include, for example, a position indicia reading stylus and a paper having a position defining indicia incorporated with a surface thereof. The manufacturers and distributors include a position indicia reading stylus manufacturer and a manufacturer of a paper having a position defining indicia incorporated with a surface thereof.

Still further in accordance with various exemplary embodiments of the present invention, a method and system are provided for affecting the distribution and sale of a position indicia reading stylus and a paper having a position defining indicia incorporated with a surface thereof. A demand may thereby be established for services in a system in which the position indicia reading stylus and the paper are used by one or more subscribers to transmit information over a communication network to a value added service provider associated with the position indicia reading stylus and the paper for a fee. The fee may accordingly be received from the one or more subscribers over a computer network whereupon the distribution and sale of the position indicia reading stylus and the paper may be subsidized by providing a portion of the fee to one or more of a position indicia reading stylus supplier and a supplier of the paper so as to enable the position indicia reading stylus supplier and the paper supplier to reduce costs. Such cost reduction thereby preferably increases supply, encouraging purchase and use of the position indicia reading stylus and the paper which increased use will necessarily generate increased fees which in turn may be used to increase the level of subsidy and so on. It will be appreciated that the fee may be one or a combination of: a periodic fee, and a use based fee and may further be received from one or a combination of: a service provider associated with the wireless communication network, and the value added service provider.

The present invention further provides an apparatus for calculating an allocation of revenue, comprising: a database tracking revenue generated by services associated with a position indicia reading stylus and a product having position defining indicia thereon; and a processor calculating revenue to be allocated to at least one of a manufacturer of the position indicia reading stylus, a distributor of the position indicia reading stylus, a manufacturer of the product, and a distributor of the product as a function of the revenue tracked by the database.

### BRIEF DESCRIPTION OF THE DRAWINGS

Further objects, features and advantages of the invention will become apparent from the detailed description given below with reference to the accompanying drawings, which are incorporated in and constitute a part of the specification and, together with the description, explain the features and principles of the invention. In the drawings:

FIG. 1 is a diagram illustrating an exemplary network environment in accordance with various exemplary embodiments of the present invention;

FIG. 2 is a diagram further illustrating an exemplary network environment in accordance with various exemplary embodiments of the present invention;

FIG. 3 is a diagram still further illustrating an exemplary network environment in accordance with various exemplary embodiments of the present invention;

FIG. 4A is an diagram of exemplary financial interaction between an end user, network operator, service provider, payment provider, and technological service provider, and pen/paper manufacturer/distributor in accordance with various exemplary billing arrangements in accordance with the present invention;

FIG. 4B is a diagram illustrating exemplary revenue flow, product flow, and fee allocation in accordance with various exemplary embodiments of the present invention; and

FIG. 5 is a general block diagram of an exemplary arrangement for calculating a revenue allocation amount in accordance with an embodiment of the present invention.

### DETAILED DESCRIPTION

The following detailed description of the invention refers to the accompanying drawings. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

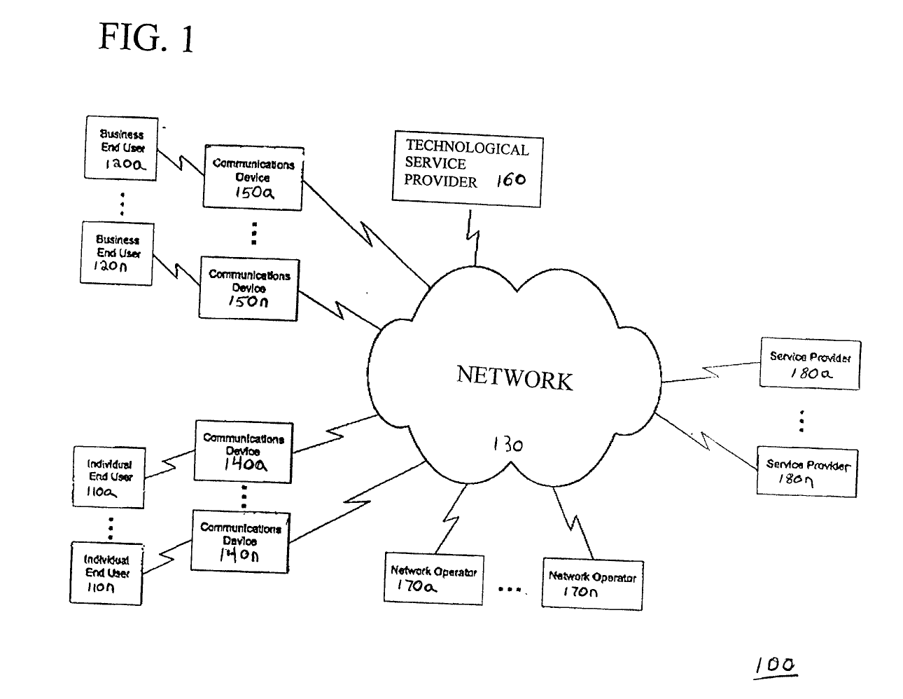

FIG. 1 illustrates an exemplary network environment to which principles of the present invention may be applied. As seen in FIG. 1, an exemplary network environment 100 includes the following main components: (1) individual end users 110a-110n; (2) business end users 120a-120n; (3) a network 130; (4) communications devices 140a-140n, respectively providing communication connections between the individual end users 110a-110n and the network 130; (5) communications devices 150a-150n, respectively providing communication connections between business end users 120a-120n and the network 130; (6) a technological service provider 160; (7) network operators 170a-170n; and (8) service providers 180a-180n. It should be readily apparent that the number and types of components in network environment 100 are not limited to what is shown in FIG. 1. For example, there may be several technological service providers.

The communications devices 140a-140n, 150a-150n, the technological service provider 160, the network operators 170a-170n, and the service provider 180a-180n are connected via the network 130, thereby enabling the exchange of information and services among these components. The network 130 may be any type of network or a combination of networks, for example having cellular wireless, landline, and/or satellite components, individually or in combination. Furthermore, although the technological service provider 160, the network operators 170a-170n, and the service providers 180a-180n are shown as discrete entities of the network environment 100, it should be recognized that the functionality of these components, discussed below, may be consolidated, such that a single entity may function as both a technological service provider and a service provider, both a technological service provider and a network operator, both a service provider and a network operator, or as a technological service provider, a service provider, and a network operator.

Network operators 170a-170n may be entities that provide end users 110a-110n, 120a-120n, technological service provider 160, and service providers 180a 180n with channels of the network 130 over which to communicate, e.g., communications services providers.

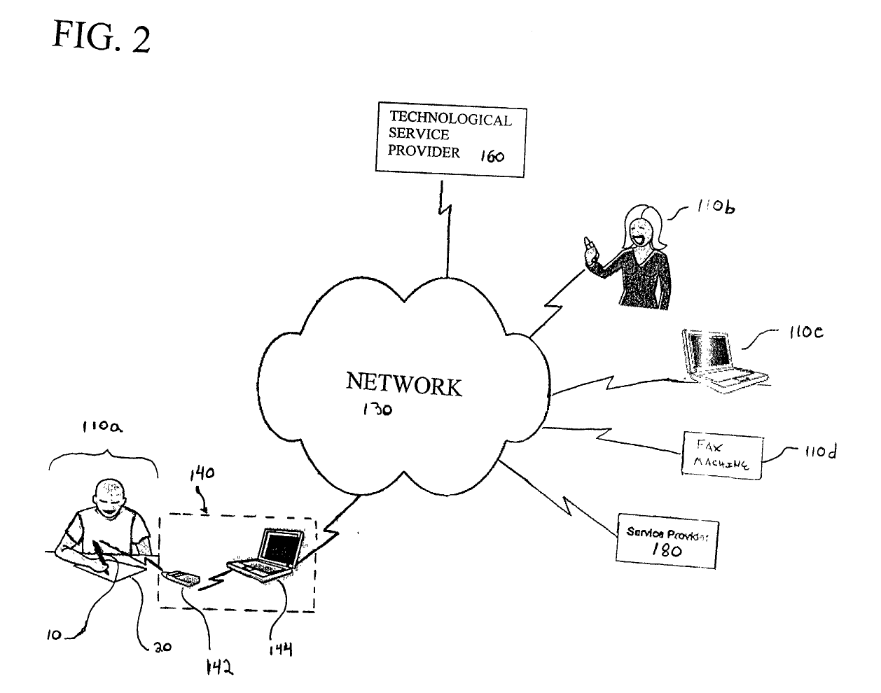

FIG. 2 is a diagram showing components of the network environment of FIG. 1 in more detail to demonstrate a possible end user environment to which principles of the present application are applicable. According to the exemplary end user environment shown in FIG. 2, an individual end user 110a uses a position indicia reading handheld device, such as a pen or stylus 10 that is able to read position indicia from a surface 20. The surface 20 having position defining indicia thereon will be referred to herein as “digital paper,” although it should be recognized that the surface 20 is not strictly limited to a paper product. As the user moves the stylus 10 across the digital paper 20, the stylus 10 detects position defining indicia to determine position/movement of the stylus 10 on the digital paper 20 and sends a signal representing, or derived from, position/movement of the stylus 10 via the communications device 140a associated with the individual end user 110a and the network 130 to the technological service provider 160, a network operator 170, a service provider 180, and/or other entities connected to the network 130. In the exemplary end user environment illustrated in FIG. 2, the communications device 140a includes a mobile phone 142a and a personal computer 144a. This arrangement for the communications device 140a is just one possibility. As described in greater detail below, the stylus/digital paper combination shown in FIG. 2 enables a variety of services and applications. The digital paper 20 may have an absolute-position-defining background pattern printed thereon, e.g., printed on the paper 20 using carbon-based black ink or another ink visible by infrared light. Such a pattern may include dots with a nominal spacing of, e.g., 0.3 mm and may be printed on paper of any desired size and shape. The dots may be slightly displaced from a virtual grid structure to form areas or windows, for example including 6×6 dots and occupying a dimension of 2×2 mm. Such an area, which may be called a “symbol,” uniquely defines an absolute position at an imaginary surface. Since each dot may occupy four different positions and since there are 36 dots, the total combination of positions that can be coded is 272, which corresponds to a surface area exceeding 60×10⁶ km². In this way, the imaginary surface may be divided into numerous sub-surfaces of various sizes, some of which may be pre-defined for certain applications, such as those discussed below, while others may be licensed to companies and/or authorities. For more detail regarding how position within the above described position defining digital paper 20 is determined see U.S. patent application Ser. No. 09/580,338 entitled “Position determination” filed May 26, 2000; and U.S. patent application Ser. No. 09/676,914 entitled “Position determination II—graphic” filed Oct. 2, 2000 the contents of which are incorporated herein by reference.

The area within a sub-surface can be used for a range of applications, each with its own assigned functionality. In addition to position-defining portions, portions of the digital paper 20 may be provided with dot patterns that represent particular functions or information fields.

The stylus 10 may be a “digital pen” having the following elements: (1) a camera including light emitting diodes that illuminate dots of the surface 20, e.g., via infrared light, and takes digital snapshots, e.g., at a rate of 100 per second, to capture images of the illuminated dots; (2) an image processor that calculates, e.g., in real-time, the position/movement/orientation of the stylus 10 on the surface 20 based on the dot pattern images captured from the surface 20; (3) a memory for storing coordinate information generated by the image processor, e.g., sufficient to store several hand-written pages; (4) a communication element, e.g., a wireless Bluetooth RF transceiver or an infrared transceiver, for sending/receiving information to/from the associated communications device 140a, or directly to the network 130; (5) an ink cartridge; (6) a force sensor that measures stylus tip force; and (7) a battery. One of skill in the art will recognize that the stylus 10 may include additional or fewer components. It should also be recognized that the stylus 10 may include a transmitter for communicating directly over a network, instead of merely a transmitter for relaying information over a network through an intermediary communications device, such as a mobile telephone, or a network connected computer or PDA (Personal Digital Assistant). The information transfer by the transceiver of the stylus 10 does not need to be wireless, but instead may be by cable. Stylus 10 may further store information as also described in U.S. patent application Ser. No. 09/580,338 entitled “Position determination” filed May 26, 2000; and U.S. patent application Ser. No. 09/676,914 entitled “Position determination II—graphic” filed Oct. 2, 2000.

Carbon-based black ink which may form the dot patterns on the surface 20 is capable of absorbing infrared light emitted from the stylus 10 so that the position identifying patterns on the surface 20 may be read by the stylus 10 regardless of other colors, or noncarbon-based black ink, printed thereon, provided the other colors do not absorb infrared light. The stylus may dispense any suitable ink at least partially transparent to the camera so that the underlying dot pattern may be read. In addition to detecting position/movement/orientation of the stylus 10 and recognizing function/field-identifying patterns, the stylus 10 may include intelligent character recognition (ICR) capabilities for interpreting letters and characters written in certain fields of the digital paper 20, e.g., for reading a handwritten email addresses, fax numbers, or phone numbers. Although an individual end user 110a is illustrated in FIG. 2, business end users 120a-120n may likewise use a position indicia reading stylus 10 and a surface 20 having position defining indicia thereto to conduct business functions.

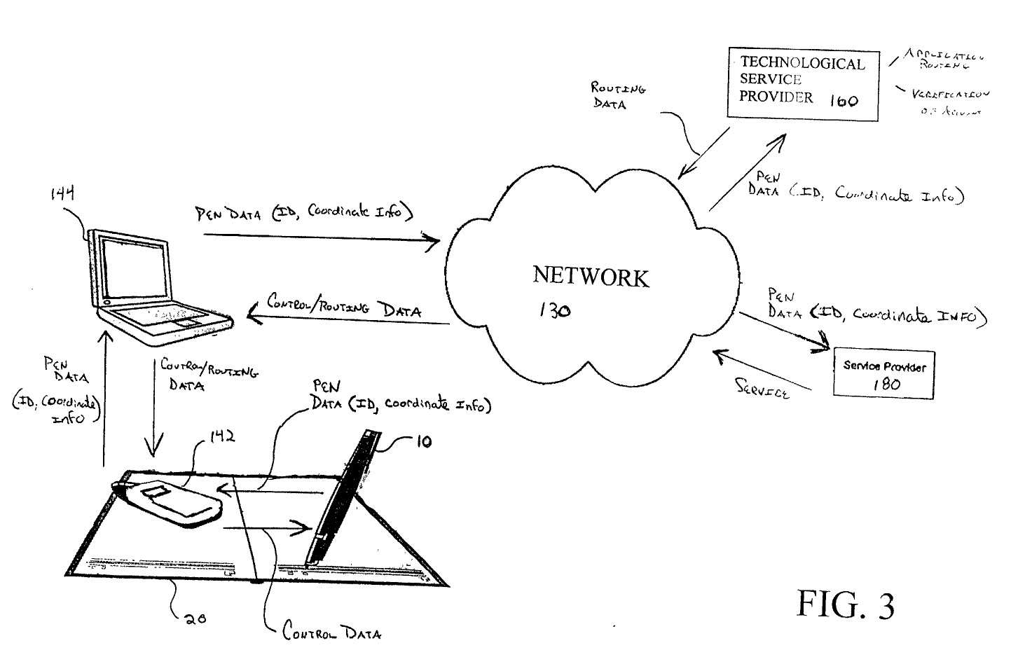

FIG. 3 illustrates an exemplary flow of information/ services for elements of the end-user/network environment of FIG. 2. As shown in FIG. 3, the stylus 10 sends stylus data, which may include a stylus-specific identification and coordinate information, representing stylus position/movement data, to the technological service provider 160 via the network 130 and the intermediate communications device 140a, which includes a mobile phone 142a, (e.g., with a Bluetooth transceiver, and a computer 144a in the example end user environment of FIG. 3. Position information may include, for example, coordinates in the imaginary surface. It should be realized that the stylus 10 may store the coordinate information and/or other stylus data in memory for sending at a later occasion/time. The technological service provider 160 may use the stylus-specific identification information for various purposes, e.g., to access, verify, and update account information of individual end user 110a and/or to update billing/account information. The information transmitted by the stylus 10 may not be limited to stylus identification and coordinate information, depending on the capabilities of the stylus 10. For example, if the stylus 10 is provided with ICR capability, the stylus 10 may transmit text information.

The technological service provider 160 may utilize the coordinate information received from the stylus 10 to determine the type of service or transaction the user is requesting, e.g., based on a service allocated to the detected position in the imaginary surface. Based on this determination, the technological service provider 160 determines the service provider that will handle the service or transaction and sends routing data to the stylus 10 via the network 130 and the communications device 140a associated with the end user 110a. The routing data instructs the stylus 10 where, and in what format, to send the previously stored coordinate information, e.g., providing the stylus with an Internet Protocol (IP) address for the server associated with the appropriate service provider 180. Next, the stylus 10 sends the previously-stored coordinate information to the appropriate service provider 180 via the communications device 140a and the network 130. Upon receiving and processing the coordinate information from the stylus 120, the service provider 180 may send control data back to the stylus 10, e.g., indicating that the service/transaction is complete so that the stylus 10 may clear its memory.

In addition to controlling routing and managing end user account information, it should be recognized that the technological service provider 160 may perform additional “value-added” services. For example, the technological service provider 160 may “translate” the coordinate information received from the stylus 10 into a format, e.g., a text data, that may be used to achieve the requested service. Furthermore, the technological service provider 160 may itself perform any necessary routing, for example by transmitting the coordinate information received from the stylus to the appropriate service provider.

The arrangements illustrated in FIGS. 2-3, and variations thereof, may support a variety of communications services and commercial transactions, such as:

Facsimile Service—The end user 110 may write a note or sketch on digital paper 20, input a facsimile number in a designated field of the digital paper 20, or at a keyboard, e.g., associated with a mobile telephone, and check a portion of the surface 20 designated for a “send” function. The technological service provider 160 receives identification and coordinate data from the stylus 10, recognizes that the end user 110 has requested facsimile service, and sends appropriate routing information to the stylus 10, e.g., routing information for a service provider 180 that supports facsimile service. Upon receiving routing information from the technological service provider 160, the stylus 10 sends the previously-stored coordinate information to the service provider 180 supporting facsimile service, which converts the coordinate information into a facsimile transmission to the designated fax number.

Email—The end user 110 may write a note or sketch on the digital paper 20, input an email address in a designated field of the digital paper 20, or at a keyboard, e.g., associated with a mobile telephone, and check a portion of the digital paper 20 designated for a “send” function. The technological service provider 160 will receive identification and coordinate data from the stylus 10, recognize that the end user 110 has requested email service, and send appropriate routing information to the stylus 10, e.g., routing information for a service provider 180 that supports email service. Upon receiving routing information from the technological service provider 160, the stylus 10 sends the previously-stored coordinate information to the service provider 180 supporting email service, which converts the coordinate information into an email message that is sent to the designated email address.

Short Message Service (SMS)—The end user 110 may write text on the digital paper 20, input a telephone number for an SMS-enabled device, e.g., a GSM mobile phone, in a designated field of the digital paper 20, or at a keyboard, e.g., associated with a mobile telephone, and check a portion of the digital paper 20 designated for a “send” function. The technological service provider 160 receives identification and coordinate data from the stylus 10, recognizes that the end user 110 has requested SMS, and sends appropriate routing information to the stylus 10, e.g., routing information for a service provider 180 or network operator 170 that supports SMS. Upon receiving routing information from the technological service provider 160, the stylus 10 sends the previously-stored coordinate information to the network operator 170 or service provider 180 supporting SMS, which converts the coordinate information into a text message that is sent to the designated SMS-enabled device, e.g., a friend's GSM mobile phone.

Commercial Transactions—The end user 100 may purchase goods or services using the stylus 10 and the digital paper 20. For example, an advertisement for flowers may be printed on the digital paper 20 with portions containing positioning identifying dot patterns. By touching an appropriate part of the advertisement with the stylus 10 and filling in order information, e.g., fields for name, address, credit card, delivery destination, etc., an order for flowers may be placed to a local flower shop, where the order can be filled.

Business Applications—Business end users 120a-120n may use the stylus 10 and the digital paper 20 in a manner similar to individual end users 110a-110n. A business end user 120 may either be an employee of or otherwise affiliated with a service provider in the arrangement. For example, a business end user 120a may be an employee of a parcel delivery service having an inventory system, and equip each delivery personnel with a stylus 10 and digital paper 20 for transmitting delivery status information to a host computer connected to the network 130. Depending on the particular business application, involvement of the technological service provider 160 may be optional.

It is important to note that technological service provider as used herein may be distinguished from service provider in that the technological service provider provides supporting services related to the use of enabling technology associated with the technological infrastructure. The service provider may provide services desirable to end users in possession of the enabling technologies and which services may make use of the supporting services such as mapping and look-up or simply position information. For example, an email service provider may make use of supporting services provided by technological service provider while providing additional value added services.

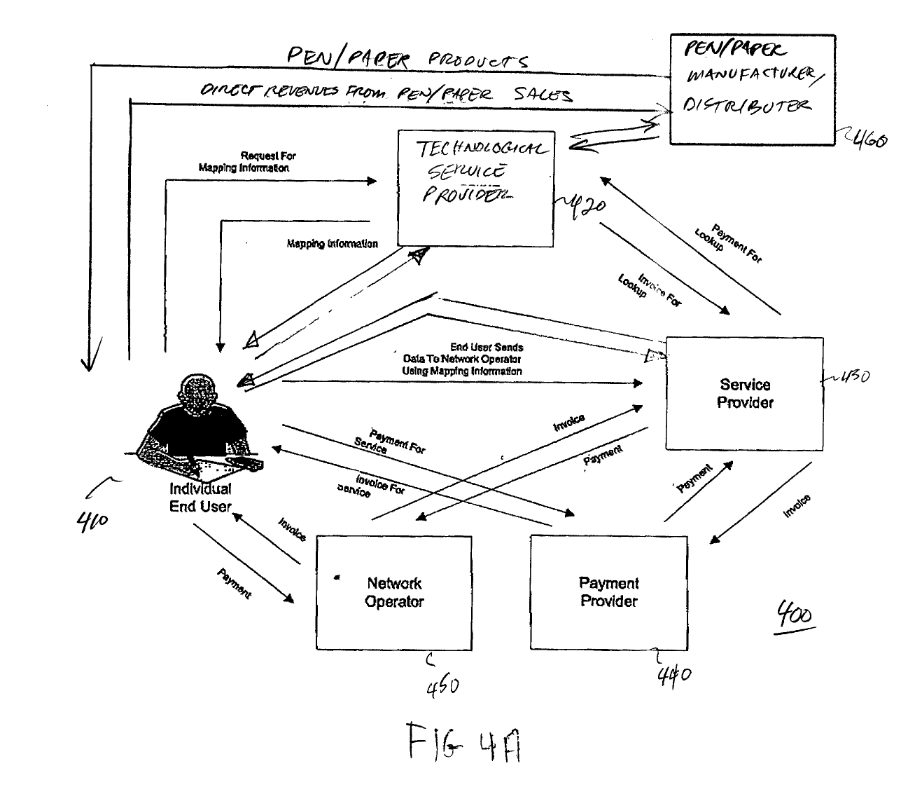

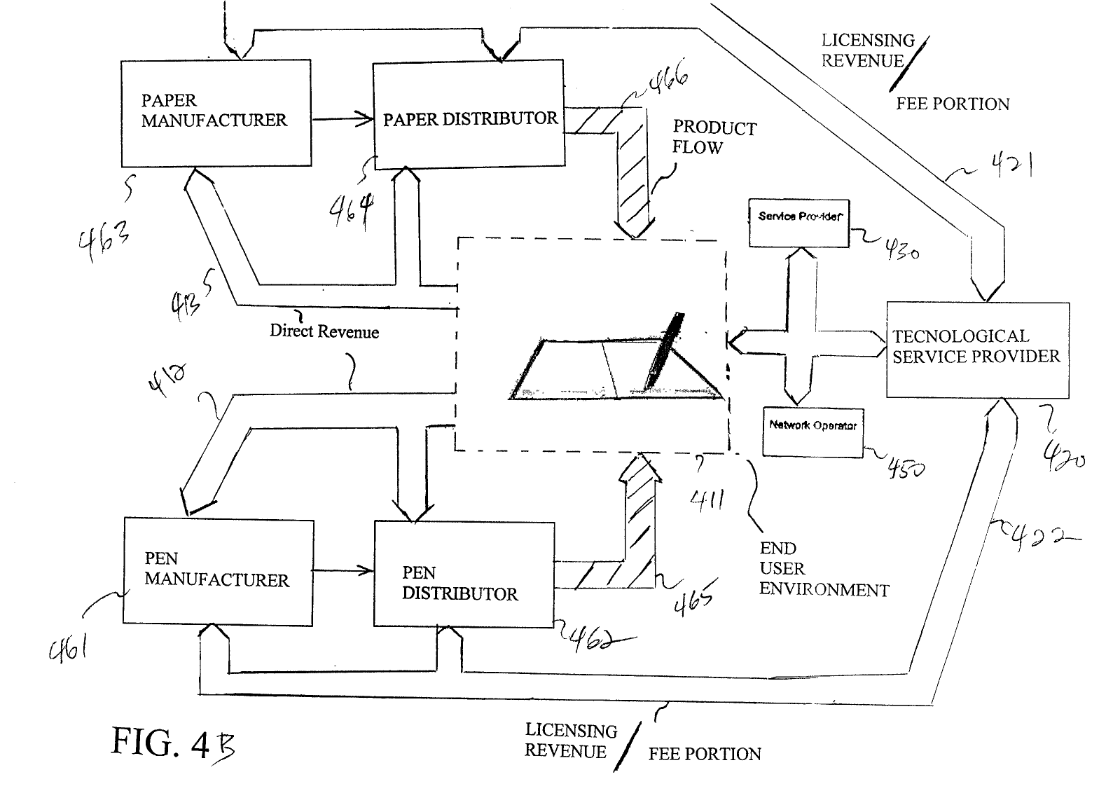

In accordance with various exemplary embodiments of the present invention, billing arrangements may be used to collect fees which will be used in various ways including to stimulate increases in the production of digital pens and digital paper as will be described in greater detail hereinafter. FIG. 4A is a diagram of several exemplary billing arrangements in accordance with the present invention. As can been seen, several billing arrangements are shown between end user 410 and one or a combination of technological service provider 420, service provider 430, payment provider 440, and network operator 450. For example, a billing arrangement between end user 410 and network operator 450 might be particularly well suited to situations where network operator 450 wants to offer end user 410 a set of basic pen-related services that might be used more often than other pen-related services. In such an arrangement, network operator 450 provides end user 410 with a pen-related service. End user 410 may use a digital pen and digital paper to access and use a service offered by network operator 450. For example, end user 410 may desire to send a graphical e-mail to a specific person. Using digital pen and digital paper, end user 410 may write a handwritten message to the intended recipient. Upon completing the message, end user 410 may, for example, touch the digital pen to an area of the digital paper designated for sending messages. Recognizing the area of the digital paper as a send command, the digital pen may send a request to technological service provider 420 via, for example, an intermediate device such as communications device 140a as illustrated in FIG. 1. Requests may include both a pen identification and position information such as, for example, coordinates in the imaginary surface.

Position information may be used, for example, to lookup and retrieve mapping information corresponding to the position information in a table including a URL of a location dedicated to the transmission of graphical e-mail. After retrieving the mapping information, technological service provider 420 may return mapping information and process any additional information such as for example, linear trace information obtained from the digital pen signal to end user 410 using, for example, the pen identification information. Linear trace information may refer to information related to a series of positions generated by the movement of the digital pen. Mapping information, e.g., a URL may be used by the digital pen to contact one or a combination of technological service provider 420, service provider 430, payment provider 440, or network operator 450, any or all of which may be configured to provide a set or subset of services by processing pen identification and position information. Once contact has been established, one or a combination of technological service provider 420, service provider 430, payment provider 440, or network operator 450 may instruct the digital pen on what data to send, how to format and tag that data, and where to send that data. The digital pen may then send one or a combination of technological service provider 420, service provider 430, payment provider 440, or network operator 450 the appropriate data, including handwritten data represented as, for example, a series of positions defining a linear trace, generated from writing on the digital paper. Thereafter, one or a combination of technological service provider 420, service provider 430, payment provider 440, or network operator 450 may perform and deliver the particular pen-based service desired by end user 410.

After performing the service, one or a combination of technological service provider 420, service provider 430, payment provider 440, or network operator 450 may bill end user 410 for the provision of service. For example, end user 410 may be invoiced by one or a combination of technological service provider 420, service provider 430, payment provider 440, or network operator 450 indicating that payment is due for the service. An itemized list of services used by end user 410 may be included in the invoice or end user 410 may be charged a lump sum. It should be noted that in accordance with various exemplary billing arrangements in accordance with the present invention, invoices may be sent each time a service is provided, or alternatively, a series of transactions may be batched together and billed to the user at one time. Invoices may alternatively be sent to an employer of end user 410 if, for example, the service is used in conjunction with business. Payments from end user 410 or end user 410's employer to one or more of technological service provider 420, service provider 430, payment provider 440, and network operator 450 may be, for example, transaction-based fees or flat rate fees. Alternatively, use of pen-related services may be part of end user 410's overall communications service agreement.

Technological service provider 420 may also independently bill one or more of service provider 430, payment provider 440, and network operator 450 for retrieval of the mapping information associated with digital pen use. For example, technological service provider 420 may send one or more of service provider 430, payment provider 440, and network operator 450 an invoice indicating that payment is due for the information retrieval, e.g., mapping information look-up. Technological service provider 420 may send an invoice after each information retrieval, wait until a predetermined number of information retrievals have been made, or wait until a predetermined monetary amount has been reached. Also, a periodic invoice may be sent, e.g., weekly, monthly, etc. It will further be appreciated that service provider 430, payment provider 440, and network operator 450 may make payments on invoices as required by predetermined arrangement.

It is important to note that any one of the various exemplary billing arrangements illustrated in FIG. 4A, might be particularly well suited to a particular situation. For example, where service provider 430 may desire to waive service costs for employees or business partners acting as end users, and instead may prefer to absorb costs as part of an agreement with network operator 450. In such an arrangement, service provider 430 provides end user 410, which may be a business or individual end user, with pen-related services. For an exemplary business end user 410, a request through the use of a digital pen and digital paper may be made for the purpose of using a service offered by service provider 430. For example, business end user 410 may be an employee or business partner of service provider 430 and desire to use a digital pen-based inventory service. Using a digital pen, business end user 410 may write on digital paper and touch the digital pen to an area of the digital paper designated for sending information. Recognizing the area of the digital paper, the digital pen sends a request to technological service provider 420 via, for example, intermediate communications device 140 including a pen identification and position information, e.g., coordinates. Mapping or related services may then be provided in the manner described hereinabove. In such a billing arrangement, costs may be passed to service provider 430 as part of the agreement. Thus, network operator 450 may bill service provider 430 per an agreement. Accordingly, one or more of technological service provider 420, payment provider 440, and network operator 450 may send service provider 430 an invoice indicating that payment is due for use of the communication channel provided. Service provider 430 may then remit payment to the one or more of technological service provider 420, payment provider 440, and network operator 450.

Technological service provider 420 may also bill service provider 430 for retrieval of the mapping information associated with a request. For example, technological service provider 420 may send service provider 430 an invoice indicating that payment is due for the information retrieval. Technological service provider 420 may send an invoice after each information retrieval, wait until a predetermined number of information retrievals have been made, or wait until a predetermined monetary amount has been reached. Also, a periodical invoice may be sent, e.g., weekly, monthly, etc. Service provider 430 may then remit appropriate payments.

In accordance with additional exemplary embodiments of the present invention, an additional alternative billing arrangement may be particularly well suited to situations where service provider 430 may want to offer a pen-related service to end user 410 which in accordance with the present embodiment is preferably an individual end user. In such an arrangement, service provider 430 may provide end user 410 with pen-related services using requests generated through a digital pen and digital paper. For example, end user 410 desiring to order flowers may do so by scanning with a digital pen a coded portion of an advertisement for flowers. As a result, an order for flowers is placed to a local flower shop, where the order can be fulfilled. The order may then be charged, for example, to end user 410's phone bill. Recipient information may be inputted and transmitted using the digital pen, and the identity of the purchaser may be known by a unique identification number transmitted by the pen along with additional information including billing address and, for example, credit card number or account number. It will be appreciated that many services can be provided in such a manner. For example, an individual end user may use a digital pen and service provided in accordance with various exemplary embodiments of the present invention to purchase plane tickets using a coded airline advertisement. In order for such a service to be completed, end user 410 may first need to touch the digital pen to an area of the digital paper designated for sending messages. Recognizing the area of the digital paper, the digital pen may send a request to technological service provider 420 including a pen identification and position information, e.g., coordinates. Further authorization or authentication may be performed by technological service provider 420 to validate users and maintain, for example, credit card information and the like. It will further be appreciated that technological service provider 420 may forward information back to the digital pen including handwriting information which may be used to provide a handwritten message on paper to accompany the flower delivery.

As in previous examples, network operator 450 may preferably bill end user 410 or service provider 430 for use of the communications channels. For example, network operator 450 may send end user 410 or service provider 430 invoices indicating that payment is due for carrying data over its communications channels. Service provider 430 may further bill end user 410 for the service performed. For example, as previously mentioned, end user 410 purchased flowers using digital pen and digital paper and may thus receive an invoice for the flowers directly from service provider 430. Alternatively, end user 410 may receive an invoice for the flowers from one or more of technological service provider 420, payment provider 440, and network operator 450 as a part of the invoice normally received from one or more of technological service provider 420, payment provider 440, and network operator 450. In that case, one or more of technological service provider 420, payment provider 440, and network operator 450 may reimburse service provider 430 for the purchased product/service, e.g., flowers.

Also as in previous examples, technological service provider 420 may also bill service provider 430 for retrieval of mapping information associated with service provider 430. For example, technological service provider 420 may send service provider 430 an invoice indicating that payment is due for the information retrieval. Technological service provider 420 may send an invoice after each information retrieval, wait until a predetermined number of information retrievals have been made, or wait until a predetermined monetary amount has been reached. Also, a periodical invoice may be sent, e.g., weekly, monthly, etc. Service provider 430 may then remit appropriate payments.

Another exemplary billing arrangement in accordance with the present invention is particularly well suited to situations where service provider 430 does not want to assume the financial risk of the transaction. Thus the service of, for example, a third party financial institution or payment provider 440 may be used. In such an arrangement, any one or a combination of technological service provider 420, service provider 430, or network operator 450 may provide end user 410 with pen-related services in the above described manner. For example, end user 410 may order furniture using an furniture advertisement with portion thereof printed on digital paper. By scanning appropriate portions of the advertisement with a digital pen, an order for furniture can be placed to a furniture shop, where the order can be fulfilled. In order for a service to be completed, end user 410 may first need to touch the digital pen to various areas of the digital paper to select options such as fabric choice. The user may then scan an area designated for sending messages. Recognizing the area of the digital paper, the digital pen may send a request to technological service provider 420 via an intermediate communications device 140a including pen identification and position information. Since furniture is a relatively costly acquisition, service provider 430 or network operator 450 may not want to assume the risk of collecting payment for an expensive service or merchandise purchase on a periodical bill such as a monthly phone bill. Thus, a third party payment provider, such as payment provider 440, might handle billing end user 410 on behalf of, for example, service provider 430, essentially assumes the financial risk of collecting payments. Service provider 430 may invoice payment provider 440 whereupon payment provider 440 may pay the invoice. Thus, service provider 430 immediately receives payment, with payment provider 440 invoicing end user 410 for the services or merchandise. One of skill in the art will recognize that network operator 450 could also provide end user 410 with expensive pen-related services and as such would benefit from the payment collection and related services provided by payment provider 440 as described hereinabove. In addition it should be noted that pen and/or paper manufacturer/distributor 460 may further collect fees for pen/paper sales to end user 410 and will have a strong financial relationship with technological service provider 420 as a result of licensing fees paid from pen and/or paper manufacturer/distributor 460 to technological service provider 420 and various additional financial arrangements in accordance with the present invention as will be described in greater detail hereinafter. It should also be noted that arrangements may be made to incorporate incentives into, for example, digital paper and digital pen distribution and sale in the form of pre-paid services as is described in greater detail in the commonly-owned application entitled “Communication System and Method for Supporting a Technology Provider of a Communications Network”, filed concurrently herewith, the entire contents of which are incorporated herein by reference.

With reference to FIG. 4B, exemplary financial relationships and product flows between various entities in a service provision environment in accordance with various embodiments of the present invention are illustrated. It is useful in understanding the present invention to begin with the provision of digital pen and digital paper making up at least a portion of the technological infrastructure supporting the provision of services to end user environment 411. Direct revenue streams 412 and 413 flow back to one or a combination of pen manufacturer 461/pen distributor 462 and paper manufacturer 463/paper distributor 464 respectively from the sale of digital pen and digital paper based on product flows 465 and 466 respectively to end user environment 411. In addition, service based fees, various exemplary embodiments of the collection of which have been previously described, may be collected from one or a combination of user environment 411, service provider 430, and network operator 450 to be transferred eventually to technological service provider 420. It should be noted that technological service provider may preferably own patented and un-patented rights in technology associated with digital pen and digital paper as described in greater or lesser detail herein and in applications incorporated by reference.

As has been described herein and as will be appreciated by those skilled in the art, the success of a service fee-based service provision environment such as in relation to the present invention, relies heavily on the rapid proliferation of devices, e.g., the digital pen and digital paper, and corresponding use and generation of fee revenues, visibility, and popularity. Accordingly, using the fees collected as described above and any additional revenues, technological service provider may allocate a portion of the fees to subsidize or otherwise provide incentives to one or a combination of pen manufacturer 461/pen distributor 462 and paper manufacturer 463/paper distributor 464 to increase the distribution and sale of digital pens and digital paper, preferably under license agreement with technological service provider 420. It will be appreciated that the portion of fees provided may offset all or a portion of licensing revenues due to technological service provider 420 however such provisions may be modified by agreement and may be affected by delay provisions and the like which provisions may further be used to stimulate sale and distribution of digital pens and digital paper by deferring such costs until volume reaches a desired, e.g., profitable, level. While paper manufacturer 463/paper distributor 464 and pen manufacturer 461 /pen distributor 462 are described together hereinabove, it will be understood that depending on circumstances, technological service provider 420 may work directly with one or the other or both manufacturers and distributors in providing incentives to increase the distribution and sale of digital pens and digital paper through fee allocation such that the exact portion of fees allocated therebetween may vary slightly. Alternatively, independent agreements may further be established between manufacturers and distributors to distribute a single allocation of fees provided to one or the other of the manufacturer or distributor from technological service provider 420 for maximum incentivization.

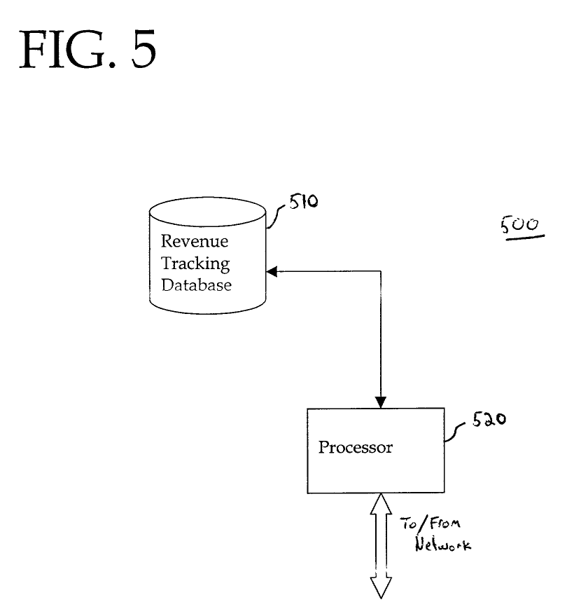

To facilitate the above-described technique for fee allocation, an implementation of the present invention utilizes an apparatus for monitoring revenues generated using the digital paper/digital pen technology and calculating the amount of revenue to be allocated to at least one of the pen manufacturer 461, pen distributor 462, paper manufacturer 463, and paper distributor 464, e.g., on a monthly basis, in accordance with the amount of revenue generated using the digital paper/digital pen technology and the previously agreed-on revenue percentage. In one implementation illustrated in FIG. 5, an apparatus 500 for calculating a fee distribution includes a database 510 for monitoring/tracking revenue generated by digital paper-/digital pen-based input technology and services and a processor 520 for calculating the revenue to be allocated to the pen manufacturer 461, pen distributor 462, paper manufacturer 463, and/or paper distributor 464 based on the amount of revenue tracked in the database 510 and the previously agreed-on share percentage. It should be recognized that the database 510 and the processor 520 may reside on a server at various nodes of the above-described communications network, e.g., at the technological service provider 160, a service provider 180, etc.

Co-pending with the application for this patent are applications entitled Systems and Methods for Information Storage based on Swedish Application No. 0000947-2, filed Mar. 21, 2000, U.S. Provisional Application No. 60/207,839, filed May 30, 2000, and U.S. utility application Ser. No. 09/812,885, filed on Mar. 21, 2001; Secured Access Using a Coordinate System based on Swedish Application No. 0000942-3, filed Mar. 21, 2000, U.S. Provisional Application No. 60/207,850 filed on May 30, 2000, and U.S. utility application Ser. No. 09/813,115, filed on Mar. 21, 2001; System and Method for Printing by Using a Position Coding Pattern based on Swedish Application No. 0001245-0, filed on Apr. 5, 2000, U.S. Provisional Application Ser. No. 60/210,651, filed on Jun. 9, 2000, and U.S. utility application Ser. No. 09/812,905, filed on Mar. 21, 2001; Apparatus and Methods Relating to Image Coding based on Swedish Application No. 0000950-6, filed on Mar. 21, 2000, U.S. Provisional Application No. 60/207,838, filed on May 30, 2000, and U.S. utility application Ser. No. 09/812,901, filed on Mar. 21, 2001; Apparatus and Methods for Determining Spatial Orientation based on Swedish Application No. 0000951-4, filed on Mar. 21, 2000, U.S. Provisional Application No. 60/207,844, filed on May 30, 2000, and U.S. utility application Ser. No. 09/812,902, filed on Mar. 21, 2001; System and Method for Determining Positional Information based on Swedish Application No. 0000949-8, filed Mar. 21, 2000, U.S. Provisional Application No. 60/207,885, filed on May 30, 2000, and U.S. utility application Ser. No. 09/812,900, filed on Mar. 21, 2001; Method and System for Transferring and Displaying Graphical Objects based on Swedish Application No. 0000941-5, filed Mar. 21, 2000, U.S. Provisional Application No. 60/208,165, filed May 31, 2000, and U.S. Utility Application Ser. No. 09/812,892, filed on Mar. 21, 2001; Online Graphical Message Service based on Swedish Application No. 0000944-9, filed Mar. 21, 2000, U.S. Provisional Application No. 60/207,881, filed May 30, 2000, and U.S. utility application Ser. No. 09/813,117, filed on Mar. 21, 2001; Method and System for Digitizing Freehand Graphics With User-Selected Properties based on Swedish Application No. 0000945-6, filed Mar. 21, 2000, U.S. Provisional Application No. 60/207,882, filed May 30, 2000, and U.S. utility application Ser. No. 09/812,882, filed on Mar. 21, 2001; Data Form Having a Position-Coding Pattern Detectable by an Optical Sensor based on Swedish Application No. 0001236-9, filed Apr. 5, 2000, U.S. Provisional Application No. 60/208,167, filed May 31, 2000, and U.S. utility application Ser. No. 09/812,906, filed on Mar. 21, 2001; Method and Apparatus for Managing Valuable Documents based on Swedish Application No. 0001252-6, filed Apr. 5, 2000, U.S. Provisional Application No. 60/210,653 filed Jun. 9, 2000, and U.S. utility application Ser. No. 09/813,116, filed on Mar. 21, 2001; Method and Apparatus for Information Management based on Swedish Application No. 0001253-4 filed Apr. 5, 2000, U.S. Provisional Application No. 60/210,652, filed Jun. 9, 2000, and U.S. utility application Ser. No. 09/826,015, filed on Apr. 5, 2001; Device and Method for Communication based on Swedish Application No. 0000940-7, filed Mar. 21, 2000, U.S. Provisional Application No. 60/208,166, filed May 31, 2000, and U.S. utility application Ser. No. 09/813,114, filed on Mar. 21, 2001; Information-Related Devices and Methods based on Swedish Application No. 0001235-1, filed Apr. 5, 2000, U.S. Provisional Application No. 60/210,647, filed Jun. 9, 2000, and U.S. utility application Ser. No. 09/812,907, filed on Mar. 21, 2001; Processing of Documents based on Swedish Application No. 0000954-8, filed Mar. 21, 2000, U.S. Provisional Application No. 60/207,849, filed May 30, 2000, and U.S. utility application Ser. No. 09/813,112, filed on Mar. 21, 2001; Secure Signature Checking System based on Swedish Application No. 0000943-1, filed Mar. 21, 2000, U.S. Provisional Application No. 60/207,880, filed May 30, 2000, and U.S. utility application Ser. No. 09/812,899, filed on Mar. 21, 2001; Identification of Virtual Raster Pattern, based on Swedish Application No. 0001235-1, filed Apr. 5, 2000, U.S. Provisional Application No. 60/210,647, filed Jun. 9, 2000, U.S. utility application Ser. No. 09/812,907, filed on Mar. 21, 2001, and Swedish Application No. 0004132-7, filed Nov. 10, 2000, and U.S. Provisional Application No. 60/261,123, filed Jan. 12, 2001; Method and Arrangement in a Digital Communication System based on Swedish Application No. 0102232-6, filed Jun. 25, 2001; Communication Protocol based on Swedish Application No. 0102418-1, filed Jul. 5, 2001, and U.S. Provisional Application No. 60/303,814 filed Jul. 10, 2001; Method and System for Communications Service Revenue Collection based on U.S. Provisional Application No. 60/281,786, filed Apr. 6, 2001; Activation of Products with Embedded Functionality in an Information Management System based on Swedish Application No. 0104398-3, filed Dec. 27, 2001, and U.S. Provisional Application No. 60/346,295, filed Jan. 9, 2002; Server Unit in Computer Network based on Swedish Application No. 0102341-5, filed Jun. 29, 2001, and U.S. Provisional Application No. 60/303,041, filed Jul. 6, 2001.

The technical disclosures of each of the above-listed U.S. applications, U.S. provisional applications, and Swedish applications are hereby incorporated herein by reference. As used herein, the incorporation of a “technical disclosure” excludes incorporation of information characterizing the related art, or characterizing advantages or objects of this invention over the related art.

While the present invention has been described in connection with various embodiments, many modifications will be readily apparent to those skilled in the art. For example, while the billing arrangements in FIGS. 2-5 have been described separately, one skilled in the art will appreciate that some or all of these arrangements can exist concurrently. One skilled in the art will also appreciate that all or part of the systems and methods consistent with the present invention may be stored on or read from computer-readable media, such as secondary storage devices, like hard disks, floppy disks, and CD-ROM; a carrier wave received from a network such as the Internet; or other forms of ROM or RAM. In addition, while the steps of the various flow charts and diagrams are presented in particular orders, one skilled in the art will appreciate that the steps may be performed in different orders, some steps may be omitted, and some steps added—all within the spirit and scope of the invention.

Further, while the description employs an exemplary embodiment of a mapping lookup service, the invention in its broadest sense is not so limited. The code detected by the pen need not be part of a larger map, but may instead contain a more directly executable instruction. The invention, therefore is not limited to the disclosure herein, but is intended to cover any adaptations or variations thereof.

In the foregoing Description of Preferred Embodiments, various features of the invention are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Preferred Embodiments, with each claim standing on its own as a separate preferred embodiment of the invention.

What is claimed is:

1. A method of affecting the rate of introduction of a technological infrastructure to establish a demand for a network of infrastructure dependent technological services, the method comprising:
collecting revenues from one or more subscribers to the infrastructure dependent technological services;
allocating a portion of the collected revenues to one or more manufacturers of one or more enabling technologies associated with the technological infrastructure to lower a direct purchase cost to the one or more subscribers of the one or more enabling technologies;
wherein step of allocating increases a distribution level of the one or more enabling technologies by subsidizing the direct purchase cost so as to increase a sales level of the one or more enabling technologies increasing the technological infrastructure directly purchased by the one or more subscribers and lowering the cost to the one or more subscribers of the directly purchased technological infrastructure.

2. The method according to claim 1, wherein the one or more enabling technologies includes a position indicia reading stylus and a paper having a position defining indicia incorporated with a surface thereof.

3. The method according to claim 1, wherein the one or more manufacturers includes a position indicia reading stylus manufacturer and a manufacturer of a paper having a position defining indicia incorporated with a surface thereof.

4. The method according to claim 1, wherein the step of collecting further includes the steps of:
providing the infrastructure dependent technological services from a technological service provider through an intermediate service provider; and
collecting the revenues using the intermediate service provider.

5. The method according to claim 4, wherein the intermediate service provider includes a wireless service provider.

6. The method according to claim 1, wherein the infrastructure dependent technological service includes a service for receiving a signal from the position indicia reading stylus, the signal representative of the position of the position indicia reading stylus on the paper and providing one or more additional services based on the represented position of the position indicia reading stylus on the paper.

7. A method of allocating collected revenues to affect the rate of introduction of a technological infrastructure needed to establish a demand for a network of infrastructure dependent technological services supplied by a technological service provider through at least one intermediate service provider, the method comprising:
collecting revenues from one or more subscribers to the infrastructure dependent technological services, from one or more of the technological service provider, and the one or more intermediate service provider; and
allocating a portion of the collected revenues to one or more of: one or more manufacturers of one or more enabling technologies and one or more distributors of the one or more enabling technologies to lower a direct purchase cost to the one or more subscribers of the one or more enabling technologies,
wherein the step of allocating increases a distribution level of the one or more enabling technologies by subsidizing the direct purchase cost so as to increase a sales level of the one or more enabling technologies increasing the technological infrastructure directly purchased by the one or more subscribers and lowering the cost to the one or more subscribers of the directly purchased technological infrastructure.

8. The method according to claim 7, wherein the one or more enabling technologies includes a position indicia reading stylus and a paper having a position defining indicia incorporated with a surface thereof.

9. The method according to claim 7, wherein the one or more manufacturers includes a position indicia reading stylus manufacturer and a manufacturer of a paper having a position defining indicia incorporated with a surface thereof.

10. The method according to claim 7, wherein the one or more distributors includes a position indicia reading stylus distributor and a distributor of a paper having a position defining indicia incorporated with a surface thereof.

11. The method according to claim 7, wherein the step of collecting further includes the step of collecting the revenues using any one or more of the one or more intermediate service provider and the technological service provider.

12. A method for affecting the distribution and sale of a position indicia reading stylus and a paper having a position defining indicia incorporated with a surface thereof to establish a demand for services in a system in which the position indicia reading stylus and the paper are used by one or more subscribers to transmit information over a communication network to a value added service provider associated with the position indicia reading stylus and the paper for a fee, the method comprising:
a) receiving the fee from the one or more subscribers over a computer network;
b) subsidizing the distribution and sale of one or more of the position indicia reading stylus and the paper by providing a portion of the fee to one or more of a position indicia reading stylus supplier and a supplier of the paper so as to enable the position indicia reading stylus supplier and the paper supplier to reduce costs thereby increasing the supply and encouraging purchase and use of the position indicia reading stylus and the paper and to thereby generate increased fees.

13. The method of claim 12, wherein the fee is one or a combination of: a periodic fee, and a use based fee.

14. The method of claim 12, wherein the step of receiving further includes receiving the fee from one or a combination of: a service provider associated with the communication network, the value added service provider.

15. A system for affecting the rate of introduction of a technological infrastructure to establish a demand for a network of infrastructure dependent technological services, the system comprising:
one or more position indicia reading stylus and associated paper having a position defining indicia incorporated with a surface thereof;
one or more manufactures of the one or more position indicia reading stylus and associated paper; and
an infrastructure dependent technological service provider, the one or more position indicia reading stylus associated with one or more subscribers to the infrastructure dependent technological services, the infrastructure dependent technological service provider capable of receiving a signal from the one or more position indicia reading stylus through an intermediate service provider, the system configured to:
collect revenues from the one or more subscribers to the infrastructure dependent technological services; and
allocate a portion of the collected revenues to one or more manufacturers of one or more enabling technologies associated with the technological infrastructure to lower a direct purchase cost to the one or more subscribers of the one or more enabling technologies;
wherein allocating increases a distribution level of the one or more enabling technologies by subsidizing the direct purchase cost so as to increase a sales level of the one or more enabling technologies increasing the technological infrastructure directly purchased by the one or more subscribers and lowering the cost to the one or more subscribers of the directly purchased technological infrastructure.

16. The system according to claim 15, wherein in collecting is further configured to:
provide the infrastructure dependent technological services from a technological service provider through an intermediate service provider; and
collect the revenues using the intermediate service provider.

17. The system according to claim 16, wherein the intermediate service provider includes a wireless service provider.

18. The system according to claim 15, wherein the infrastructure dependent technological service includes a service for receiving a signal from the position indicia reading stylus, the signal representative of the position of the position indicia reading stylus on the associated paper and providing one or more additional services based on the represented position of the position indicia reading stylus on the paper.

19. A system for allocating collected revenues to affect the rate of introduction of a technological infrastructure needed to establish a demand for a network of infrastructure dependent technological services supplied by a technological service provider through at least one intermediate service provider, the system comprising:
a technological infrastructure; and
a technological service provider for receiving information from and providing services to one or more subscribers of the infrastructure dependent technological services associated with the technological infrastructure, the system configured to:
collect revenues from the one or more subscribers to the infrastructure dependent technological services, from one or more of the technological service provider, and the one or more intermediate service provider; and
allocate a portion of the collected revenues to one or more manufacturers of one or more enabling technologies associated with the technological infrastructure to lower a direct purchase cost to the one or more subscribers of the one or more enabling technologies;
wherein allocating increases a distribution level of the one or more enabling technologies by subsidizing the direct purchase cost so as to increase a sales level of the one or more enabling technologies increasing the technological infrastructure directly purchased by the one or more subscribers and lowering the cost to the one or more subscribers of the directly purchased technological infrastructure.

20. The system according to claim 19, wherein the one or more enabling technologies includes a position indicia reading stylus and a paper having a position defining indicia incorporated with a surface thereof.

21. The system according to claim 19, wherein the one or more manufacturers includes a position indicia reading stylus manufacturer and a manufacturer of a paper having a position defining indicia incorporated with a surface thereof.

22. The system according to claim 19, wherein the one or more distributors includes a position indicia reading stylus distributor and a distributor of a paper having a position defining indicia incorporated with a surface thereof.

23. The system according to claim 19, wherein, in collecting, is further configured to collect the revenues using any one or more of the one or more intermediate service provider and the technological service provider.

24. A system for affecting the distribution and sale of a position indicia reading stylus and a paper having a position defining indicia incorporated with a surface thereof to establish a demand for services in a system in which the position indicia reading stylus and the paper are used by one or more subscribers to transmit information over a communication network to a value added service provider associated with the position indicia reading stylus and the paper for a fee, the system comprising:
a technological infrastructure; and
a technological service provider for receiving information from and providing services to one or more subscribers of the infrastructure dependent technological services associated with the technological infrastructure, the system configured to:
receive the fee from the one or more subscribers over a computer network;
subsidize the distribution and sale of one or more of the position indicia reading stylus and the paper by providing a portion of the fee to one or more of a position indicia reading stylus supplier and a supplier of the paper so as to enable the position indicia reading stylus supplier and the supplier of the paper to reduce costs thereby increasing the supply and encouraging purchase and use of the position indicia reading stylus and the paper and to thereby generate increased fees.

25. The system of claim 24, wherein the fee is one or a combination of a periodic fee, and a use based fee.

26. The system of claim 24, wherein in receiving is further configured to: receive the fee from one or a combination of a service provider associated with a wireless communication network, and a value added service provider.

27. An apparatus for calculating an allocation of revenue, comprising:
a database tracking revenue generated by services associated with a position indicia reading stylus and a product having position defining indicia thereon; and
a processor calculating revenue to be allocated to at least one of a manufacturer of said position indicia reading stylus, a distributor of said position indicia reading stylus, a manufacturer of said product, and a distributor of said product as a function of the revenue tracked by said database.
